(19) United States
(12) Patent Application Publication
(10) Pub. No.: US 2026/0193545 A1
(43) Pub. Date: Jul. 9, 2026

(54) ZEOLITE CATALYSTS AND METHODS FOR CRACKING HYDROCARBON STREAMS SUCH AS CRUDE OILS UTILIZING SAME

(71) Applicants: Saudi Arabian Oil Company, Dhahran (SA); King Fahd University of Petroleum and Minerals, Dhahran (SA)

(72) Inventors: Mohammed Alkhunaizi, Dhahran (SA); Munir D. Khokhar, Dhahran (SA); Mohammad Abdullah, Al Khobar (SA); Aniz Chennampilly Ummer, Dhahran (SA); Ziyauddin S. Qureshi, Dhahran (SA); Rajesh Theravalappil, Dhahran (SA); Mohammed Alalouni, Dhahran (SA)

(73) Assignees: Saudi Arabian Oil Company, Dhahran (SA); King Fahd University of Petroleum and Minerals, Dhahran (SA)

(21) Appl. No.: 19/012,375

(22) Filed: Jan. 7, 2025

(51) Int. Cl. C10G 11/05; B01J 29/40; B01J 35/63; B01J 37/00; B01J 37/28

(52) U.S. Cl. CPC C10G 11/05; B01J 29/40; B01J 35/633; B01J 37/0009; B01J 37/28; C10G 2300/1088; C10G 2300/4006; C10G 2300/4012; C10G 2300/4018; C10G 2400/20

(57) ABSTRACT

An extruded cracking catalyst may comprise a zeolite component mixed with an alumina binder. The zeolite component comprises ZSM-5 having a SiO₂/Al₂O₃ molar ratio greater than or equal to 50. The alumina binder is formed via peptization with at least 1 wt/wt % phosphoric acid. A hydrocarbon feed stream may be cracked by contacting the hydrocarbon feed stream with the extruded cracking catalyst in a reactor unit.

### BACKGROUND

### Field

The present disclosure relates to the cracking of hydrocarbons, and more particularly to extruded zeolite catalysts and methods for cracking hydrocarbon streams by the extruded zeolite catalysts.

### Technical Background

Light olefins such as ethylene and propylene are basic intermediates for a large portion of the petrochemical industry. They are mainly obtained through the thermal cracking (sometimes referred to as “steam pyrolysis” or “steam cracking”) of petroleum gases and distillates such as naphtha, kerosene, or even gas oil. However, as demands rise for these basic intermediate compounds, other production sources must be considered beyond traditional thermal cracking processes utilizing petroleum gases and distillates as feedstocks.

These intermediate compounds may also be produced through refinery fluidized catalytic cracking (FCC) processes, where heavy feedstocks such as gas oils or residues are converted. For example, an important source for propylene production is refinery propylene from the cracking of distillate feedstocks such as gas oils or residues. However, these feedstocks are usually limited and result from several costly and energy intensive processing steps within a refinery.

### BRIEF SUMMARY

Accordingly, in view of the ever growing demand of these intermediary petrochemical products such as ethylene and propylene, there is a need for processes and catalyst systems to produce these intermediate compounds from other types of feedstock materials, such as relatively light crude oil supplies like gas condensate. For example, there is a need for catalysts and processes for converting gas condensate crude feedstock. According to one embodiment, the present disclosure is related to extruded cracking catalysts and processes for producing these intermediate compounds such as light olefins, sometimes referred to in this disclosure as “system products,” by the direct conversion of feedstock crude oils such as gas condensate. For example, production of light olefins from light hydrocarbon feedstocks, such as gas condensate, may be beneficial as compared with the conversion of other feedstocks in producing these intermediate compounds because the light hydrocarbon feedstocks may be more widely available, may involve less processing costs to convert to light olefins, or both. However, new cracking catalysts are needed to selectively convert light hydrocarbon feedstocks to products with relatively high yields of light olefins such as ethylene and propylene.

According to one or more embodiments, an extruded cracking catalyst may comprise a zeolite component mixed with an alumina binder. The zeolite component comprises ZSM-5 has a SiO₂/Al₂O₃ molar ratio greater than or equal to 50. The alumina binder is formed via peptization with at least 1 wt/wt % phosphoric acid.

According to another embodiment, a hydrocarbon feed stream may be cracked by a method comprising contacting the hydrocarbon feed stream with an extruded cracking catalyst in a reactor unit. The hydrocarbon feed stream may include a hydrocarbon having at least 5 carbons per molecule. The zeolite component comprises ZSM-5 having a SiO₂/Al₂O₃ molar ratio greater than or equal to 50. The alumina binder is formed via peptization with at least 1 wt/wt % phosphoric acid.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 depicts a generalized schematic diagram of an embodiment of a fluid catalytic cracking reactor unit, according to one or more embodiments described in this disclosure;

FIG. 2 depicts a scanning electron microscope (SEM) image of a comparative cracking catalyst;

FIG. 3 depicts a SEM image of a comparative cracking catalyst;

FIG. 4 depicts a SEM image of an exemplary cracking catalyst, according to one or more embodiments described in this disclosure;

FIG. 5 depicts a SEM image of another exemplary cracking catalyst, according to one or more embodiments described in this disclosure;

FIG. 6 depicts a SEM image of an exemplary cracking catalyst, according to one or more embodiments described in this disclosure;

FIG. 7 depicts a transmission electron microscope (TEM) image of a comparative cracking catalyst at 50,000 (50K) magnification;

FIG. 8 depicts a TEM image of the comparative cracking catalyst of FIG. 7 at 600,000 (600K) magnification;

FIG. 9 depicts a TEM image of a comparative cracking catalyst at 50,000 (50K) magnification;

FIG. 10 depicts a TEM image of the comparative cracking catalyst of FIG. 9 at 600,000 (600K) magnification;

FIG. 11 depicts a TEM image of an exemplary cracking catalyst at 50,000 (50K) magnification, according to one or more embodiments described in this disclosure;

FIG. 12 depicts a TEM image of the exemplary cracking catalyst of FIG. 11 at 60,000 (60K) magnification; and

FIG. 13 depicts X-ray diffraction patterns of comparative cracking catalysts and exemplary cracking catalysts, according to one or more embodiments described in this disclosure.

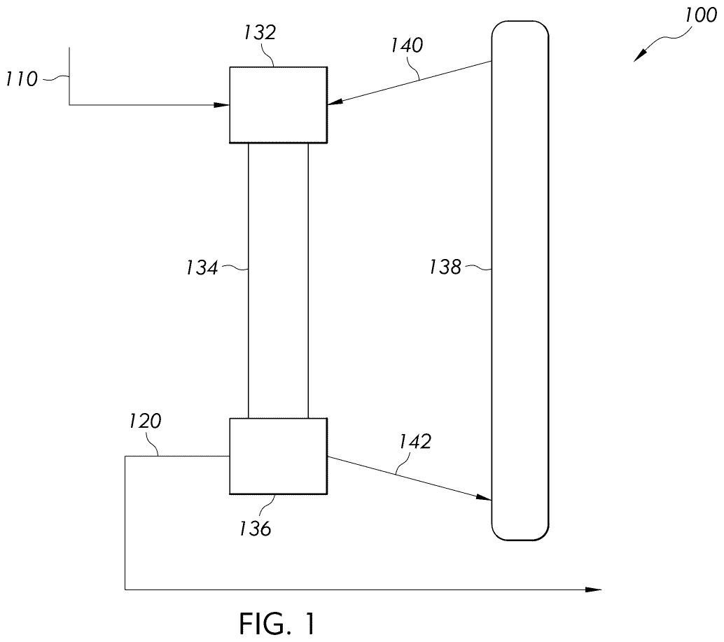

For the purpose of describing the simplified schematic illustrations and descriptions of FIG. 1, the numerous valves, temperature sensors, electronic controllers and the like that may be employed and well known to those of ordinary skill in the art of certain chemical processing operations are not included. Further, accompanying components that are often included in conventional chemical processing operations, such as refineries, such as, for example, air supplies, catalyst hoppers, and flue gas handling are not depicted. It should be understood that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines which may serve to transfer process steams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Described in this disclosure are various embodiments of extruded cracking catalysts and methods for processing hydrocarbon feed streams, such as light crude oils, into petrochemical products such as streams that include ethylene and propylene. Generally, the extruded cracking catalyst may comprise a zeolite component mixed with an alumina binder. The zeolite component may comprise ZSM-5 having a SiO₂/Al₂O₃ molar ratio greater than or equal to 50. The alumina binder may be formed via peptization with at least 1 wt/wt % phosphoric acid.

According to some embodiments of the present disclosure, the processing of the hydrocarbon feed stream may include cracking of the hydrocarbon feed stream by contacting the hydrocarbon feed stream with the extruded cracking catalysts. The hydrocarbon feed stream may comprise a hydrocarbon comprising at least 5 carbons per molecule. The hydrocarbon feed stream may comprise a relatively light crude oil, such as gas condensate. As described in the present disclosure, “crude oil” refers to fuels which have been minimally processed or not processed following extraction from their respective sources. For example, gas condensate is considered a crude oil even though it may undergo minimal processing to separate vapor fractions from liquid fractions in the formation of the gas condensate. Additionally, crude oils may include hydrocarbon feedstocks which have been minimally processed such as by the partial or full removal of unwanted contaminants such as one or more of sulfur, heavy metals, nitrogen, or aromatics, such as by hydroprocessing. Moreover, it should be understood that while some embodiments presently described are related to the cracking of crude oil feedstocks, other embodiments may be directed to the cracking of fractions of crude oil feedstocks or partially refined hydrocarbon feedstocks.

The extruded cracking catalyst converts the hydrocarbon feed stream into a product stream that may include, without limitation, dry gases (that is, one or more of hydrogen gas, methane, and ethane), liquefied petroleum gases (that is, one or more of propane and butane), light olefins (that is, ethylene and propylene), gasoline (that is, hydrocarbons having 4 to 12 carbons per molecule, including alkanes, cycloalkanes, and olefins), and coke. It should be understood that not all hydrocarbons of the feed stream are cracked by the extruded cracking catalyst and, generally, mostly heavier components of the feed are cracked.

Without being bound by theory, it is believed that the combination of an extruded cracking catalyst including a zeolite component having a relatively high SiO₂/Al₂O₃ molar ratio (e.g., greater than or equal to 50) and an alumina binder that has been peptized using at least 1% phosphoric acid promotes conversion of the hydrocarbon feed stream to a product stream having an enhanced yield of light olefin olefins (i.e., a total light olefin selectivity (ethylene selectivity+propylene selectivity)) greater than or equal to 40 wt %). Without being bound by theory, it is believed that a relatively high SiO₂/Al₂O₃ molar ratio (e.g., greater than or equal to 50) may suppress the excess cracking of a hydrocarbon comprising at least 5 carbons per molecule (e.g., pentene), resulting in the desired total light olefin selectivity. A relatively low SiO₂/Al₂O₃ molar ratio (e.g., less than 50), may aromatize and oligomerize the hydrocarbon feed stream, resulting in lesser olefins. Without being bound by theory, it is believed that peptizing with phosphoric acid helps to achieve desired physicochemical properties of the catalysts, such as acidity, porosity, and other morphologic properties.

As used in this disclosure, an “extruded cracking catalyst” refers to any substance which increases the rate of a cracking chemical reaction. As used in this disclosure, “extruded” refers to a material that has been added, blended, and extruded from, for example, a twin extruder. As used in this disclosure, “cracking” generally refers to a chemical reaction where a molecule having carbon to carbon bonds is broken into more than one molecule by the breaking of one or more of the carbon to carbon bonds, or is converted from a compound which includes a cyclic moiety, such as an aromatic, to a compound which does not include a cyclic moiety or contains fewer cyclic moieties than prior to cracking. However, while extruded cracking catalysts promote cracking of a reactant, the extruded cracking catalyst is not limited to cracking functionality, and may, in some embodiments, be operable to promote other reactions. “Extruded cracking catalyst” and “cracking catalyst” are used interchangeably throughout.

As described herein, in one or more embodiments, the zeolite component of the extruded cracking catalyst may comprise ZSM-5. In one embodiment, the ZSM-5 may comprise a SiO₂/Al₂O₃ molar ratio greater than or equal to 50. In various embodiments, the SiO₂/Al₂O₃ molar ratio of the ZSM-5 may be from 100 to 1000. In embodiments, the ZSM-5 may comprise a SiO₂/Al₂O₃ molar ratio greater than or equal to 50, greater than or equal to 100, greater than or equal to 150, greater than or equal to 200, or even greater than or equal to 250. In embodiments, the ZSM-5 may comprise a SiO₂/Al₂O₃ molar ratio less than or equal to 1000, less than or equal to 800, less than or equal to 600, or even less than or equal to 400. In embodiments, the ZSM-5 may comprise a SiO₂/Al₂O₃ molar ratio from 50 to 1000, from 50 to 800, from 50 to 600, from 50 to 400, from 100 to 1000, from 100 to 800, from 100 to 600, from 100 to 400, from 150 to 1000, from 150 to 800, from 150 to 600, from 150 to 400, from 200 to 1000, from 200 to 800, from 200 to 600, from 200 to 400, from 250 to 1000, from 250 to 800, from 250 to 600, or even from 250 to 400. The acidity is defined by the ratio of silica to alumina groups in the zeolite component. Without being bound by theory, lower alumina content in the zeolite framework may decrease the Brønsted acidity, as framework aluminum ions facilitates the presence of protons, which act as Brønsted acid sites. The total acid strength of the zeolite component may be increased because the removal of aluminum ions provide way to Lewis sites, which are relative stronger than Brønsted sites. The increase in acid strength may be caused by the charge density on the proton of the —OH group being highest when there is no framework aluminum in the second coordination sphere. The Brønsted acidity of the zeolite component is a key parameter driving the catalytic properties. Hence, any reduction of the Brønsted acidity directly affects the overall performance of the extruded cracking catalyst. Accordingly, an extruded cracking catalyst including a zeolite component comprising a SiO₂/Al₂O₃ molar ratio less than 50 (e.g., having a relatively high alumina content) may not perform as well as a zeolite composition catalyst with a SiO₂/Al₂O₃ ratio greater than or equal to 50.

In embodiments, the zeolite component may further comprise (e.g., be impregnated with) one or more active metals for catalysis. For example, the one or more active metals may be from Groups 1, 2, 13, 14, and 15 of the IUPAC Periodic Table. In one or more embodiments, the active metal may be selected from Group 1 of the IUPAC Periodic Table, such as lithium, sodium, potassium, rubidium, cesium, francium, or combinations thereof. In some embodiments, the one or more active metals may be from Group 15 of the IUPAC Period Table, such as nitrogen, phosphorous, arsenic, antimony, bismuth, moscovium, or combinations thereof. The active metal may exist within the final extruded cracking catalyst as an elemental metal.

According to one or more embodiments, the extruded cracking catalyst may comprise from 5 wt % to 75 wt % of the zeolite component. In various embodiments, the amount of the zeolite component in the extruded cracking catalyst may be greater than or equal to 5 wt %, greater than or equal to 10 wt %, greater than or equal to 15 wt %, greater than or equal to 20 wt %, or even greater than or equal to 25 wt %. In some embodiments, the amount of the zeolite component in the extruded cracking catalyst may be less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, or even less than or equal to 35 wt %. In one or more embodiments, the amount of the zeolite component in the extruded cracking catalyst may be from 5 wt % to 75 wt %, from 5 wt % to 70 wt %, from 5 wt % to 65 wt %, from 5 wt % to 60 wt %, from 5 wt % to 55 wt %, from 5 wt % to 50 wt %, from 5 wt % to 45 wt %, from 5 wt % to 40 wt %, from 5 wt % to 35 wt %, from 10 wt % to 75 wt %, from 10 wt % to 70 wt %, from 10 wt % to 65 wt %, from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 15 wt % to 75 wt %, from 15 wt % to 70 wt %, from 15 wt % to 65 wt %, from 15 wt % to 60 wt %, from 15 wt %, to 55 wt %, from 15 wt % to 50 wt %, from 15 wt % to 45 wt %, from 15 wt % to 40 wt %, from 15 wt % to 35 wt %, from 20 wt % to 75 wt %, from 20 wt % to 70 wt %, from 20 wt % to 65 wt %, from 20 wt % to 60 wt %, from 20 wt % to 55 wt %, from 20 wt % to 50 wt %, from 20 wt % to 45 wt %, from 20 wt % to 40 wt %, from 20 wt % to 35 wt %, from 25 wt % to 75 wt %, from 25 wt % to 70 wt %, from 25 wt % to 65 wt %, from 25 wt % to 60 wt %, from 25 wt % to 55 wt %, from 25 wt % to 50 wt %, from 25 wt % to 45 wt %, from 25 wt % to 40 wt %, or even from 25 wt % to 35 wt %, or any and all sub-ranges formed from any of these endpoints.

As described herein, in one or more embodiments, the extruded cracking catalyst includes an alumina binder. As used in this disclosure, “alumina binder” refers to alumina-containing materials which may serve to “glue” or otherwise hold the zeolite together. The alumina binder may comprise alumina (such as amorphous alumina) or silica-alumina (such as amorphous silica-alumina). According to one or more embodiments, the alumina binder may comprise pseudoboehmite. As used in this disclosure, “pseudoboehmite” refers to an aluminum-containing compound with the chemical composition AlO(OH) consisting of crystalline boehmite. Suitable pseudoboehmite includes CATAPAL® aluminas, commercially available from Sasol Limited of Johannesburg, South Africa. Boehmite refers to aluminum oxide hydroxide as well, but pseudoboehmite generally has a greater amount of water than boehmite.

The alumina binder, such as pseudoboehmite, may be peptized with phosphoric acid (“H₃PO₄”). For example, the alumina binder may be formed via peptization with at least 1 wt/wt % phosphoric acid, at least 2 wt/wt % phosphoric acid, at least 3 wt/wt % phosphoric acid, at least 4 wt/wt % phosphoric acid, or even at least 5 wt/wt % phosphoric acid.

According to one or more embodiments, the extruded cracking catalyst may comprise from 50 wt % to 90 wt % of the alumina binder. In various embodiments, the amount of the alumina binder in the extruded cracking catalyst may be greater than or equal to 50 wt %, greater than or equal to 55 wt %, greater than or equal to 60 wt %, or even greater than or equal to 65 wt %. In some embodiments, the amount of the alumina binder in the extruded cracking catalyst may be less than or equal to 90 wt %, less than or equal to 85 wt %, less than or equal to 80 wt %, or even less than or equal 75 wt %. In one or more embodiments, the amount of the alumina binder in the extruded cracking catalyst may be from 50 wt % to 90 wt %, from 50 wt % to 85 wt %, from 50 wt % to 80 wt %, from 50 wt % to 75 wt %, from 55 wt % to 90 wt %, from 55 wt % to 85 wt %, from 55 wt % to 80 wt %, from 55 wt % to 75 wt %, from 60 wt % to 90 wt %, from 60 wt % to 85 wt %, from 60 wt % to 80 wt %, from 60 wt % to 75 wt %, from 65 wt % to 90 wt %, from 65 wt % to 85 wt %, from 65 wt % to 80 wt %, or even from 65 wt % to 75 wt %, or any and all sub-ranges formed from any of these endpoints.

In one or more embodiments, the extruded cracking catalyst may further comprise one or more matrix materials. As use in this disclosure, “matrix materials” may refer to a clay material such as kaolin. Without being bound by theory, it is believed that the matrix materials of the catalyst serve both physical and catalytic functions. Physical functions include providing particle integrity and attrition resistance, acting as a heat transfer medium, and providing a porous structure to allow diffusion of hydrocarbons into and out of the catalyst microspheres. The matrix can also affect catalyst selectivity, product quality and resistance to poisons. The matrix materials may tend to exert its strongest influence on overall catalytic properties for those reactions which directly involve relatively large molecules.

The extruded cracking catalyst may be formed by a variety of processes. According to one embodiments, the alumina binder may be mixed with phosphoric acid diluted with fluid such as water to form a slurry. The zeolite component may be combined with the peptized alumina binder slurry with a fluid such as water in certain amounts to achieve a desired water content and form an extrudable dough, as may be analyzed using, for example, loss on ignition. The extrudable dough may be filled into an extruder and extruded to form a shaped product, such as a tablet or pellet. The shape product may have any suitable shape, which may be based on the process and reactor design, such as sphere, cylinder, and trilobe. The extruded material may be dried and then calcinated, to produce the extruded cracking catalyst.

The extruded cracking catalyst may be deactivated by contact with steam prior to use in a reactor to convert hydrocarbons. The purpose of steam treatment is to accelerate the hydrothermal aging which occurs in an operational FCC regenerator to obtain an equilibrium catalyst. Steam treatment may lead to the removal of aluminum from the framework leading to a decrease in the number of sites where framework hydrolysis can occur under hydrothermal and thermal conditions. This removal of aluminum results in an increased thermal and hydrothermal stability in dealuminated zeolites. The unit cell size may decrease as a result of dealumination since the smaller SiO₄ tetrahedron replaces the larger AlO₄⁻ tetrahedron. The acidity of zeolites may also affected by dealumination through the removal of framework aluminum and the formation of extra-framework aluminum species. Dealumination may affect the acidity of the zeolite by decreasing the total acidity and increasing the acid strength of the zeolite. The total acidity may decrease because of the removal of framework aluminum, which act as Bronsted acid sites. The acid strength of the zeolite may be increased because of the removal of paired acid sites or the removal of the second coordinate next nearest neighbor aluminum. The increase in the acid strength may be caused by the charge density on the proton of the OH group being highest when there is no framework aluminum in the second coordination sphere.

According to one or more embodiments, the extruded cracking catalyst may comprise a surface area defined by a Brunauer-Emmett-Teller (BET) Analysis (also known as specific surface area) of at least 200 m²/g, at least 250 m²/g, or at least 300 m²/g. The BET surface area represents the total surface area of a material per mass unit. Furthermore, the extruded cracking catalyst may comprise an external area of at least 150 m²/g, at least 200 m²/g, or even at least 250 m²/g.

According to one or more embodiments, the extruded cracking catalyst may comprise a pore volume from 0.05 cm³/g to 0.3 cm³/g. In various embodiments, the extruded cracking catalyst may comprise a pore volume greater than or equal to 0.05 cm³/g, greater than or equal to 0.1 cm³/g, or even greater than or equal to 0.15 cm³/g. In some embodiments, the extruded cracking catalyst may comprise a pore volume less than or equal to 0.3 cm³/g or even less than or equal to 0.3 cm³/g. In one or more embodiments, the extruded cracking catalyst may comprise a pore volume from 0.05 cm³/g to 0.3 cm³/g, from 0.05 cm³/g to 0.25 cm³/g, from 0.1 cm³/g to 0.3 cm³/g, from 0.1 cm³/g to 0.25 cm³/g, from 0.15 cm³/g to 0.3 cm³/g, or even from 0.15 cm³/g to 0.25 cm³/g. In various embodiments, the extruded cracking catalyst may comprise an average pore diameter of at least 25 angstroms (Å).

According to one or more embodiments, the extruded cracking catalyst may comprise a crystallinity from 50% to 95%. In various embodiments, the extruded cracking catalyst may comprise a crystallinity greater than or equal to 50%, greater than or equal to 60%, greater than or equal to 70%, or even greater than or equal to 80%. In some embodiments, the extruded cracking catalyst may comprise a crystallinity less than or equal to 95% or even less than or equal to 90%. In one or more embodiments, the extruded cracking catalyst may comprise a crystallinity from 50% to 95%, from 50% to 90%, from 60% to 95%, from 60% to 90%, from 70% to 95%, from 70% to 90%, from 80% to 95%, or even from 80% to 90%.

According to one or more embodiments, the hydrocarbon feed stream may be contacted by the extruded cracking catalyst in a reactor unit. As used in this disclosure, a “reactor unit” refers to a vessel or series of vessels in which one or more chemical reactions may occur between one or more reactants in the presence of one or more catalysts. For example, a reactor may include a tank or tubular reactor configured to operate as a batch reactor, a continuous stirred-tank reactor (CSTR), or a plug flow reactor. Example reactors include packed bed reactors such as fixed bed reactors, and fluidized bed reactors.

As depicted in FIG. 1, according to one or more embodiments, the reactor unit used to convert the hydrocarbon feed stream may be a fluidized bed reactor. As used in this disclosure, a “fluid catalytic cracking reactor” refers to a reactor unit that can be operable to contact a fluidized reactant with a solid material (usually in a shaped form (e.g., pellets)), such as an extruded cracking catalyst. As described in this disclosure, a fluidized bed reactor which cracks a reactant stream with a fluidized solid cracking catalyst may be referred to as a fluid catalytic cracking reactor unit.

FIG. 1 schematically depicts a fluid catalytic cracking reactor unit 100 which converts a hydrocarbon feed stream 110 into a product stream 120. The embodiment of FIG. 1 includes cracking catalyst regeneration functionality.

Still referring to FIG. 1, the hydrocarbon feed stream 110 may be passed to a fluid catalytic cracking reactor unit 100. The fluid catalytic cracking reactor unit 100 may include a cracking catalyst/feed mixing zone 132, a reaction zone 134, a separation zone 136, and a cracking catalyst regeneration zone 138. The hydrocarbon feed stream 110 may be introduced to the cracking catalyst/feed mixing zone 132 where it is mixed with regenerated cracking catalyst from regenerated catalyst stream 140 passed from the cracking catalyst regeneration zone 138. The hydrocarbon feed stream 110 is reacted by contact with the regenerated cracking catalyst in the reaction zone 134, which cracks the contents of the hydrocarbon feed stream 110. Following the cracking reaction in the reaction zone 134, the contents of the reaction zone 134 are passed to the separation zone 136 where the cracked product of the reaction zone 134 is separated from spent catalyst, which is passed in a spent catalyst stream 142 to the cracking catalyst regeneration zone 138 where it is regenerated by, for example, removing coke from the spent cracking catalyst. The product stream 120 is passed from the fluid catalytic cracking reactor unit, where it may be further processed, for example by separation into multiple streams.

It should be understood that fluid catalytic cracking reactor unit 100 of FIG. 1 is a simplified schematic of one particular embodiment of a fluid catalytic cracking reactor unit, and other configurations of fluid catalytic cracking reactor units may be suitable for the presently disclosed hydrocarbon cracking methods. For example, in some embodiments, the catalyst may not be recycled, and in such embodiments, the components of FIG. 1 related to the regeneration of the cracking catalyst would not be present.

The hydrocarbon feed stream 110 may be a crude oil feedstock, or may be processed in some way prior to being cracked. For example a relatively heavy oil may be separated into two or more components to form the hydrocarbon feed stream 110. In some embodiments, the hydrocarbon feed stream 110 may be processed to remove components such as one or more of metals, sulfur, or nitrogen prior to being treated with the cracking catalysts presently described. According to various embodiments, at least 50 wt %, at least 60 wt %, at least 70 wt %, at least 80 wt %, at least 90 wt %, at least 95 wt %, or even at least 99 wt % of the hydrocarbon feed stream may be crude oil such as gas condensate.

According to one or more embodiments, the hydrocarbon feed stream 110 may have a boiling point profile as described by the 5 wt % boiling temperature, the 25 wt % boiling temperature, the 50 wt % boiling temperature, the 75 wt % boiling temperature, and the 95 wt % boiling temperature. These respective boiling temperatures correspond to the temperature at which a given weight percentage of the hydrocarbon feed stream boils. In some embodiments, the hydrocarbon feed stream 100 may have one or more of a 5 wt % boiling temperature of less than 150° C., a 25 wt % boiling temperature of less than 225° C., a 50 wt % boiling temperature of less than 300° C., a 75 wt % boiling temperature of less than 400° C., and a 95 wt % boiling temperature of less than 600° C. According to one or more embodiments, the hydrocarbon feed stream 100 may have one or more of a 5 wt % boiling temperature rom 0° C. to 100° C., a 25 wt % boiling temperature from 75° C. to 175° C., a 50 wt % boiling temperature from 150° C. to 250° C., a 75 wt % boiling temperature from 250° C. to 350° C., and a 95 wt % boiling temperature from 450° C. to 550° C.

According to one or more embodiments, the hydrocarbon feed stream 110 may be contacted with the extruded cracking catalyst (e.g., in the reaction zone 134) at a weight hourly space velocity (WHSV) from 1 h⁻¹ to 50 h⁻¹. In various embodiments, the hydrocarbon feed stream 110 may be contacted with the extruded cracking catalyst at a WHSV greater than or equal to 1 h⁻¹ or even greater than or equal to 2 h⁻¹¹. In some embodiments, the hydrocarbon feed stream 110 may be contacted with the extruded cracking catalyst at a WHSV less than or equal to 50 h⁻¹, less than or equal to 40 h⁻¹, less than or equal to 30 h⁻¹, less than or equal to 20 h⁻¹, less than or equal to 10 h⁻¹, or even less than or equal to 5 h⁻¹. In one or more embodiments, the hydrocarbon feed stream 110 may be contacted with the extruded cracking catalyst at a WHSV from 1 h⁻¹ to 50 h⁻¹, from 1 h⁻¹ to 40 h⁻¹, from 1 h⁻¹ to 30 h⁻¹, from 1 h⁻¹ to 20 h⁻¹, from 1 h⁻¹ to 10 h⁻¹, from 1 h⁻¹ to 5 h⁻¹, from 2 h⁻¹ to 50 h⁻¹, from 2 h⁻¹ to 40 h⁻¹, from 2 h⁻¹ to 30 h⁻¹, from 2 h⁻¹ to 20 h⁻¹, from 2 h⁻¹ to 10 h⁻¹, or even from 2 h⁻¹ to 5 h⁻¹. While not wishing to be bound by theory, it is believed that as the WHSV increases, the amount gaseous olefin products, such as ethylene and propylene, decreases, resulting in greater olefin conversion.

According to one or more embodiments, the hydrocarbon feed stream 110 may be contacted with the extruded cracking catalyst at a temperature from 200° C. to 700° C. and at a pressure from greater than 0 atm to 10 atm. In various embodiments, the hydrocarbon feed stream 110 may be contacted with the extruded cracking catalyst at a temperature from 200° C. to 700° C., from 200° C. to 650° C., from 200° C. to 600° C., from 300° C. to 700° C., from 300° C. to 650° C., from 300° C. to 600° C., from 400° C. to 700° C., from 400° C. to 650° C., from 400° C. to 600° C., from 500° C. to 700° C., from 500° C. to 650° C., or even from 500° C. to 600° C. In various embodiments, the hydrocarbon feed stream 110 may be contacted with the extruded cracking catalyst at a pressure from greater than 0 atm to 10 atm, from greater than 0 to 7 atm, from greater than 0 to 5 atm, from greater than 0 to 3 atm, from 1 atm to 10 atm, from 1 atm to 7 atm, from 1 atm to 5 atm, or even from 1 atm to 3 atm.

According to one or more embodiments, the contacting the hydrocarbon feed stream 110 with the cracking catalyst produces a product stream 120 that may comprise a total light olefin selectivity (i.e., ethylene selectivity+propylene selectivity) from 40 wt % to 60 wt %. In various embodiments, the amount of light olefins in the product stream 120 may be greater than or equal to 40 wt %, greater than or equal to 43 wt %, or even greater than or equal to 45 wt %. In some embodiments, the amount of light olefins in the product stream 120 may be less than or equal to 60 wt %, less than or equal to 57 wt %, less than or equal to 55 wt %, less than or equal to 53 wt %, or even less than or equal to 50 wt %. In one or more embodiments, the amount of light olefins in the product stream 120 may be from 40 wt % to 60 wt %, from 40 wt % to 57 wt %, from 40 wt % to 55 wt %, from 40 wt % to 53 wt %, from 40 wt % to 50 wt %, from 43 wt % to 60 wt %, from 43 wt % to 57 wt %, from 43 wt % to 55 wt %, from 43 wt % to 53 wt %, from 43 wt % to 50 wt %, from 45 wt % to 60 wt %, from 45 wt % to 57 wt %, from 45 wt % to 55 wt %, or even from 45 wt % to 53 wt %, or even from 45 wt % to 50 wt %.

In one or more embodiments, the contacting the hydrocarbon feed stream 110 with the extruded cracking catalyst produces a product stream 120 that may comprise an ethylene selectivity from 15 wt % to 30 wt %, from 15 wt % to 27 wt %, from 15 wt % to 25 wt %, from 15 wt % to 23 wt %, from 15 wt % to 20 wt %, from 17 wt % to 30 wt %, from 17 wt % to 27 wt %, from 17 wt % to 25 wt %, from 17 wt % to 23 wt %, or even from 17 wt % to 20 wt %. In one or more embodiments, the contacting the hydrocarbon feed stream 110 with the extruded cracking catalyst produces a product stream 120 that may comprise a propylene selectivity from 25 wt % to 40 wt %, from 25 wt % to 37 wt %, from 25 wt % to 35 wt %, from 25 wt % to 33 wt %, from 25 wt % to 30 wt %, from 27 wt % to 40 wt %, from 27 wt % to 37 wt %, from 27 wt % to 35 wt %, from 27 wt % to 33 wt %, from 27 wt % to 30 wt %, from 30 wt % to 40 wt %, from 30 wt % to 37 wt %, from 30 wt % to 35 wt %, or even from 30 wt % to 33 wt %.

According to one or more embodiments, the contacting the hydrocarbon feed stream 110 with the extruded cracking catalyst produces a product stream 120 that may comprise a feed conversion (e.g., ((pentene-2 inlet concentration-pentene 2 outlet concentration)/pentene-2 inlet concentration)×100) from 60 wt % to 100 wt %. In various embodiments, the product stream 120 may comprise a feed conversion greater than or equal to 60 wt %, greater than or equal to 70 wt %, greater than or equal to 80 wt %, or even greater than or equal to 90 wt %. In some embodiments, the product stream 120 may comprise a feed conversion less than or equal to 100 wt %, less than or equal to 97 wt %, or even less than or equal to 95 wt %. In one or more embodiments, the product stream 120 may comprise a feed conversion from 60 wt % to 100 wt %, from 60 wt % to 97 wt %, from 60 wt % to 95 wt %, from 70 wt % to 100 wt %, from 70 wt % to 97 wt %, from 70 wt % to 95 wt %, from 80 wt % to 100 wt %, from 80 wt % to 97 wt %, from 80 wt % to 95 wt %, from 90 wt % to 100 wt %, from 90 wt % to 97 wt %, or even from 90 wt % to 95 wt %.

According to one or more embodiments, the contacting the hydrocarbon feed stream 110 with the extruded cracking catalyst produces a product stream 120 that may comprise a gas yield from 60 wt % to 99 wt % and a liquid yield from 1 wt % to 40 wt %. Without being bound by theory, the formation of gaseous products may indicate that catalytic cracking occurred. In various embodiments, the product stream 120 may comprise a gas yield greater than or equal to 60 wt %, greater than or equal to 70 wt %, greater than or equal to 80 wt %, or even greater than or equal to 90 wt %. In some embodiments, the product stream 120 may comprise a gas yield less than or equal to 99 wt %, less than or equal to 97 wt %, or even less than or equal to 95 wt %. In embodiments, the product stream 120 may comprise a gas yield from 60 wt % to 99 wt %, from 60 wt % to 97 wt %, from 60 wt % to 95 wt %, from 70 wt % to 99 wt %, from 70 wt % to 97 wt %, from 70 wt % to 95 wt %, from 80 wt % to 99 wt %, from 80 wt % to 97 wt %, from 80 wt % to 95 wt %, from 90 wt % to 99 wt %, from 90 wt % to 97 wt %, or even from 90 wt % to 95 wt %. In various embodiments, the product stream 120 may comprise a liquid yield greater than or equal to 1 wt %, greater than or equal to 3 wt %, or even greater than or equal to 5 wt %. In various embodiments, the product stream 120 may comprise a liquid yield less than or equal to 40 wt %, less than or equal to 30 wt %, less than or equal to 20 wt %, or even less than or equal to 10 wt %. In various embodiments, the product stream 120 may comprise a liquid yield from 1 wt % to 40 wt %, from 1 wt % to 30 wt %, from 1 wt % to 20 wt %, from 1 wt % to 10 wt %, from 3 wt % to 40 wt %, from 3 wt % to 30 wt %, from 3 wt % to 20 wt %, from 3 wt % to 10 wt %, from 5 wt % to 40 wt %, from 5 wt % to 30 wt %, from 5 wt % to 20 wt %, or even from 5 wt % to 10 wt %.

### EXAMPLES

The various embodiments of extruded cracking catalysts and methods for cracking hydrocarbon feed streams will be further clarified by the following examples. The examples are illustrative in nature, and should not be understood to limit the subject matter of the present disclosure.

### Example 1—Cracking Catalyst Preparation

A number of extruded cracking catalysts were prepared with varying amounts of ZSM-5 and alumina binder. Comparative Sample A includes 100% ZSM-5. Comparative Sample B and Example Samples 1-3 included 30 wt % ZSM-5 and 70 wt % alumina binder. The ZSM-5 used was CBV 28014 zeolite commercially available from Zeolyst International, which has a silica to alumina ratio of 280. The alumina binder used was CATAPAL® commercially available from Sasol. To prepare Comparative Sample A, the ZSM-5 was extruded with the help of a hydraulic press to form pellets, with no further treatment.

To prepare Comparative Sample B, a slurry of the alumina binder was prepared by mixing the alumina binder (dry basis) with 0.2 mL concentrated nitric acid diluted to 2 mL with deionized water (i.e., 3 wt/wt % nitric acid). The slurry was mulled for 20 minutes. The ZSM-5 was added to the peptized alumina binder and mixed, with the addition of enough water to get an extrudable dough. The extrudable dough was filled into a stainless barrel hand extruder fixed with a 1.1 mm plain extrusion die plate. The extrudable dough was extruded with the help of a hydraulic press to form pellets. The pellets were dried at ambient temperature for 2 hours and then was dried at 100° C. for 8 hours. The dried pellets were then calcined at 500° C. for 6 hours at a ramping rate of 2° C. per minute. The calcined pellets were then cooled to ambient temperature to produce particles and packed.

To prepare Example Sample 1, a slurry of the alumina binder was prepared by mixing the alumina binder (dry basis) with 0.45 mL concentrated phosphoric acid diluted to 2 mL with deionized water (i.e., 1 wt/wt % phosphoric acid). The slurry was mulled for 20 minutes. The ZSM-5 was added to the peptized alumina binder and mixed, with the addition of enough water to get an extrudable dough. The extrudable dough was filled into a stainless barrel hand extruder fixed with a 1.1 mm plain extrusion die plate. The extrudable dough was extruded with the help of a hydraulic press to form pellets. The pellets were dried at ambient temperature for 2 hours and then was dried at 100° C. for 8 hours. The dried pellets were then calcined at 500° C. for 6 hours at a ramping rate of 2° C. per minute. The calcined pellets were then cooled to ambient temperature to produce particles and packed.

Example Sample 2 was prepared using the same steps as Example Sample 1 except that the slurry of the alumina binder was prepared by mixing the alumina binder (dry basis) with 1.3 mL concentrated phosphoric acid diluted to 5 mL with deionized water (i.e., 3 wt/wt % phosphoric acid).

Example Sample 3 was prepared using the same steps as Example Sample 1 except that the slurry of the alumina binder was prepared by mixing the alumina binder (dry basis) with 2.2 mL concentrated phosphoric acid diluted to 2 mL with deionized water (i.e., 5 wt/wt % phosphoric acid).

### Example 2—Catalyst Characterization

### N₂ Adsorption-desorption Analysis

Referring now to Table 1, nitrogen adsorption at −195° C. was performed for Comparative Sample A and Example Samples 1-3 on a Micrometrics AutoChem 2020. Physical properties such as surface area, pore volume, and average pore diameter were calculated using Brunauer-Emmett-Teller (BET) analysis, single-point pore volume, and Barrett-Joyner-Halenda (BJH) methods. The microporous and external areas were differentiated using t-plot calculations.

TABLE 1

| | Compar- | Compar- | Exam- | Exam- | Exam- |
|---|---|---|---|---|---|
| | ative | ative | ple | ple | ple |
| | Sam- | Sam- | Sam- | Sam- | Sam- |
| | ple A | ple B | ple 1 | ple 2 | ple 3 |
| BET surface | 366.5 | 348.9 | 312.6 | 290.8 | 271.4 |
| area (m²/g) | | | | | |
| t-Plot external | 171.1 | 307.4 | 219.8 | 258.2 | 187.8 |
| area (m²/g) | | | | | |
| BJH desorption | 63.7 | 317.9 | 112 | 253.9 | 85.6 |
| area (m²/g) | | | | | |
| Single point | 0.23 | 0.28 | 0.24 | 0.22 | 0.17 |
| adsorption pore | | | | | |
| volume (cm³/g) | | | | | |
| t-Plot micropore | 0.097 | 0.025 | 0.048 | 0.022 | 0.047 |
| volume (cm³/g) | | | | | |
| BJH adsorption | 0.127 | 0.232 | 0.184 | 0.169 | 0.101 |
| cumulative volume | | | | | |
| of pores (cm³/g) | | | | | |
| BJH Desorption | 41 | 32.8 | 51 | 30 | 35 |
| average pore | | | | | |
| diameter (Å) | | | | | |

The results show the effect of increasing the phosphoric acid content on the surface area and pore diameter. In particular, as phosphoric acid content is increased, the surface area and the average pore diameter of the extruded cracking catalyst is decreased. While not wishing to be bound by theory, it is believe that the decreased in surface area and average pore diameter may be due to pore blocking.

### Scanning Electron Microscope (SEM) and Transmission Electron Microscope (TEM) Images

The morphology and elemental composition of the samples were analyzed by using FESEM LYRA-3 dual beam, Tescan (SE & BE; 30 kV) equipped with an EDX Oxford Instruments attachment. Conductive copper tapes were used to place the sample and the coating was carried out under vacuum using a Cressington ion-coater (15 mA, 20 Seconds). In order to capture TEM images, Field emission TEM JEM2100F, JOEL (200 kV accelerating voltage), and the sample suspensions were prepared from the dry sample using ethanol followed by ultrasonic treatment for 10 minutes. A droplet (5 μL) of diluted suspensions was deposited in a 400-mesh pure carbon grid and then kept in a pumping station for 1 hour for further drying.

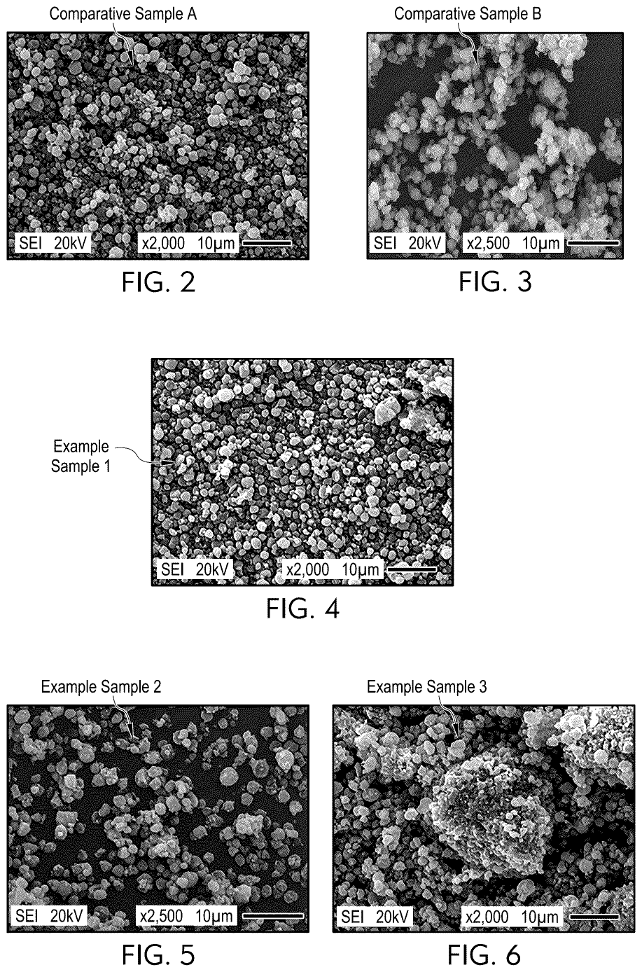

Referring now to FIGS. 2-6, Comparative Samples A and B and Example Samples 1-3 depict uniform morphology for the samples, irrespective of phosphoric acid content. The aggregate particle size observed from SEM was about 1 micron. As shown in FIG. 6, Example Sample 3 had a tendency to agglomerate to form loosely bonded aggregates.

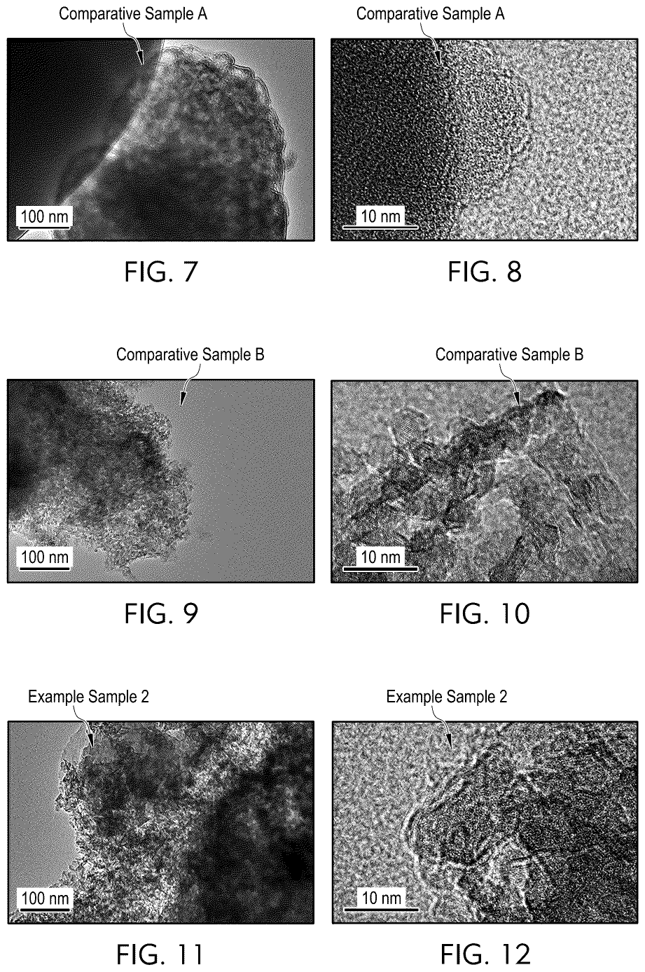

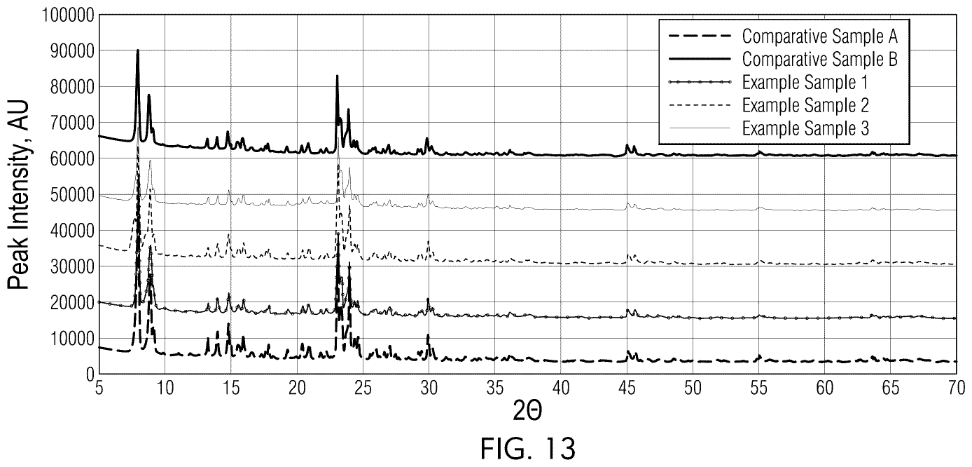

Referring now to FIGS. 7-12, bright spots through the particles demonstrate mesopores. As shown in FIGS. 7 and 8, Comparative Sample A was clean and uniform, whereas for Comparative Sample B and Example Sample 2 shown in FIGS. 9-12, the addition of alumina binder added additional grains to the morphology.

### X-Ray Diffraction

XRD analysis was performed on a Rigaku Mini-flex II system using nickel-filtered Cu Kα radiation (λ=1.5406 A, 30 kV, 15 mA) and a tube current and accelerating voltage of 30 mA and 40 kV respectively. Analyses were performed in static scanning mode with a detector angular speed of 2° per minute and a step size of 0.02°. XRD diffractograms are integrated using PDXL software to calculate peak intensities, crystallite sizes, and d-values.

Referring now to FIG. 10, the characteristic profile of ZSM-5 is shown for all of the samples. The characteristic peaks of gamma alumina could not be distinguished and separated due to merging of peaks. Among the samples, the difference in phosphorus content also count not been seen in the patters, as it was only present in a concentration of up to 5 wt/wt %.

### Crush Test

Crush strengths of pellets were evaluated according to the ASTM D4179 standard. The procedure for crush test and sample preparation are as follows. Examples Samples 1-3 were re-calcined, after an initial length screening, at 400° C. for 2 hours in a Carbolite muffle furnace to remove any moisture absorbed. The pellets were transferred to a desiccator to allow them to cool down to room temperature. Crush strength was evaluated using a MATEC crush tester (Crush-BK-500 from Materials Technology). The cell loads (N) at which each pellet breaks were noted and divided by the pellet length to obtain the results in N/mm.

Referring now to Table 2, as the percentage of phosphoric acid used for peptization is increased, the crush strength and, thus, the physical integrity of the shaped pellets is increased.

TABLE 2

| | Compar- | Exam- | Exam- | Exam- |
|---|---|---|---|---|
| | ative | ple | ple | ple |
| | Sample B | Sample 1 | Sample 2 | Sample 3 |
| Average crush (N/mm) | 9.8 | 1.0 | 3.50 | 6.55 |
| Maximum crush | 12.9 | 1.5 | 4.90 | 10.71 |
| (N/mm) | | | | |
| Minimum crush (N/mm) | 6.9 | 0.3 | 2.15 | 4.65 |

### Example 3—Catalytic Testing

Catalytic cracking was carried out in a fixed-bed microactivity testing unit (“MAT”) unit, manufactured by Sakuragi Rikagaku of Japan, according to ASTM D-3907 and D-5154 testing protocols. For each MAT run, a full mass balance was obtained and was found to be at least 97%. All MAT runs were performed at a cracking temperature of 550° C. and atmospheric pressure, with a WHSV of 10 h⁻¹ and using 2-pentene and diluent nitrogen gas, and a time-on-stream of 30 seconds.

Coke on the spent catalyst was determined using a Horiba Carbon-Sulfur Analyzer Model EMIA-220V. About one gram of the spent catalyst (with tungsten added as combustion promoters) was burnt in the high temperature furnace. The resulting combustion gas (CO₂) was passed through an Infra-Red Analyzer and the carbon content was calculated as a percent of the catalyst weight.

Data related to the catalytic activity of the catalyst formulations is provided in Table 3.

TABLE 3

| | Compar- | Exam- | Exam- | Exam- |
|---|---|---|---|---|
| | ative | ple | ple | ple |
| | Sam | Sam- | Sam- | Sam- |
| | ple A | ple 1 | ple 2 | ple 3 |
| Peptization (wt/wt %) | — | 1 | 3 | 5 |
| Conversion (wt %) | 92.5 | 88.10 | 91.32 | 95.99 |
| Ethylene selectivity (wt %) | 12.45 | 18.15 | 17.24 | 21.98 |
| Propylene selectivity | 25.81 | 25.23 | 25.63 | 33.28 |
| (wt %) | | | | |
| Total light olefin | 39.26 | 43.38 | 42.87 | 55.26 |
| selectivity (wt %) | | | | |
| Trans-pentene-2 (wt %) | 3.28 | 5.35 | 3.74 | 1.86 |
| Cis-pentene-2 (wt %) | 4.23 | 6.54 | 4.94 | 2.15 |
| Hydrogen (dry gas) (wt %) | 0.15 | 0.28 | 0.21 | 0.12 |
| Gas yield (wt %) | 93.39 | 90.72 | 91.51 | 96.28 |
| Liquid yield wt %) | 6.50 | 9.28 | 8.49 | 3.72 |
| Coke yield (wt %) | 0.1131 | 0.0027 | 0.0028 | 0.0013 |

The results show the effect of an extruded cracking catalyst as described herein on the yield of light olefins. In particular, an extruded cracking catalyst including ZSM-5 having a SiO₂/Al₂O₃ molar ratio greater than or equal to 50 and alumina binder formed via peptization with at least 1 wt/wt % phosphoric acid results in improved total light olefin selectivity as compared to a formulation including only ZSM-5. Therefore, it may be advantageous to peptize the alumina binder with phosphoric acid in order to increase the light olefin yield.

Referring now to Table 4, Example Sample 3 was subjected to the same catalytic testing as described with respect to Table 3, except that the WHSV was altered as listed in Table 4.

TABLE 4

| | Exam- | Exam- | Exam- | Exam- |
|---|---|---|---|---|
| | ple | ple | ple | ple |
| | Sample | Sample | Sample | Sample |
| | 3-1 | 3-2 | 3-3 | 3-4 |
| Peptization (wt/wt %) | 5 | 5 | 5 | 5 |
| WHSV (h⁻¹) | 2.5 | 5.0 | 10.0 | 15.0 |
| Conversion (wt %) | 98.31 | 93.09 | 95.99 | 77.58 |
| Ethylene selectivity (wt %) | 30.00 | 14.99 | 21.98 | 6.06 |
| Propylene selectivity (wt %) | 35.99 | 18.13 | 33.28 | 9.18 |
| Total light olefin | 65.99 | 33.12 | 55.26 | 15.24 |
| selectivity (wt %) | | | | |
| Trans-pentene-2 (wt %) | 0.71 | 2.97 | 1.86 | 9.96 |
| Cis-pentene-2 (wt %) | 0.98 | 3.94 | 2.15 | 12.45 |
| Hydrogen (dry gas) (wt %) | 0.42 | 0.62 | 0.12 | 0.15 |
| Gas yield (wt %) | 99.99 | 82.99 | 96.28 | 69.71 |
| Liquid yield wt %) | 0.01 | 17.01 | 3.72 | 30.29 |
| Coke yield (wt %) | 0.0041 | 0.0035 | 0.0013 | 0.0025 |

The results generally show that as WHSV increases, total olefin selectivity decreases. Therefore, it may be advantageous to in order to utilize an extruded cracking catalyst having a relatively high WHSV to increase the light olefin yield.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

According to a first aspect of the present disclosure, an extruded cracking catalyst may comprise a zeolite component mixed with an alumina binder, wherein the zeolite component comprises ZSM-5 comprising a SiO₂/Al₂O₃ molar ratio greater than or equal to 50, and wherein the alumina binder is formed via peptization with at least 1 wt/wt % phosphoric acid.

A second aspect of the present disclosure may include the first aspect, wherein the alumina binder is formed via peptization with at least 3 wt/wt % phosphoric acid.

A third aspect of the present disclosure may include the first aspect or the second aspect, wherein the SiO₂/Al₂O₃ molar ratio of the ZSM-5 is from 100 to 1000.

A fourth aspect of the present disclosure may include any one of the first through third aspects, wherein the extruded cracking catalyst comprises from 5 wt % to 75 wt % of the zeolite component.

A fifth aspect of the present disclosure may include any one of the first through fourth aspects, wherein the alumina binder comprises pseudoboehmite.

A sixth aspect of the present disclosure may include any one of the first through fifth aspects, wherein the extruded cracking catalyst comprises from 50 wt % to 90 wt % of the alumina binder.

A seventh aspect of the present disclosure may include any one of the first through sixth aspects, wherein the extruded cracking catalyst comprises a pore volume from 0.05 cm³/g to 0.3 cm³/g.

An eighth aspect of the present disclosure may include any one of the first through seventh aspects, wherein the extruded cracking catalyst comprises a crystallinity from 50% to 95%.

According to a ninth aspect of the present disclosure, a method for cracking a hydrocarbon feed stream may comprise contacting the hydrocarbon feed stream with an extruded cracking catalyst in a reactor unit, where the hydrocarbon feed stream comprises a hydrocarbon comprising at least 5 carbons per molecule, and where the extruded cracking catalyst comprises a zeolite composite catalyst mixed with an alumina binder, where the zeolite composite catalyst comprises ZSM-5 comprising a SiO₂/Al₂O₃ molar ratio greater than or equal to 50, and where the alumina binder is peptized with at least 1 wt/wt % phosphoric acid.

A tenth aspect of the present disclosure may include the ninth aspect, wherein the contacting of the hydrocarbon feed stream with the extruded cracking catalyst occurs at a weight hourly space velocity (WHSV) from 1 h⁻¹ to 50 h⁻¹.

An eleventh aspect of the present disclosure may include the ninth aspect or the tenth aspect, wherein the contacting of the hydrocarbon feed stream with the extruded cracking catalyst occurs at a temperature from 200° C. to 700° C. and at a pressure from greater than 0 atm to 10 atm.

A twelfth aspect of the present disclosure may include any one of the ninth through eleventh aspects wherein the contacting of the hydrocarbon feed stream with the extruded catalyst produces a product stream comprising a total olefin selectivity from 40% to 60%.

A thirteenth aspect of the present disclosure may include any one of the ninth through twelfth aspects, wherein the contacting of the hydrocarbon feed stream with the extruded cracking catalyst produces a product stream comprising a feed conversion from 60 wt % to 100 wt %.

A fourteenth aspect of the present disclosure may include any one of the ninth through thirteenth aspects, wherein the contacting of the hydrocarbon feed stream with the extruded cracking catalyst produces a product stream comprising a gas yield from 60 wt % to 99 wt % and a liquid yield from 1 wt % to 40 wt %.

A fifteenth aspect of the present disclosure may include any one of the ninth through fourteenth aspects, wherein the hydrocarbon stream comprises gas condensate.

1. An extruded cracking catalyst comprising:
a zeolite component mixed with an alumina binder,
wherein the zeolite component comprises ZSM-5 comprising a SiO₂/Al₂O₃ molar ratio greater than or equal to 50, and
wherein the alumina binder is formed via peptization with at least 1 wt/wt % phosphoric acid.

2. The extruded cracking catalyst of claim 1, wherein the alumina binder is formed via peptization with at least 3 wt/wt % phosphoric acid.

3. The extruded cracking catalyst of claim 1, wherein the SiO₂/Al₂O₃ molar ratio of the ZSM-5 is from 100 to 1000.

4. The extruded cracking catalyst of claim 1, wherein the extruded cracking catalyst comprises from 5 wt % to 75 wt % of the zeolite component.

5. The extruded cracking catalyst of claim 1, wherein the alumina binder comprises pseudoboehmite.

6. The extruded cracking catalyst of claim 1, wherein the extruded cracking catalyst comprises from 50 wt % to 90 wt % of the alumina binder.

7. The extruded cracking catalyst of claim 1, wherein the extruded cracking catalyst comprises a pore volume from 0.05 cm³/g to 0.3 cm³/g.

8. The extruded cracking catalyst of claim 1, wherein the extruded cracking catalyst comprises a crystallinity from 50% to 95%.

9. A method for cracking a hydrocarbon feed stream, the method comprising:
contacting the hydrocarbon feed stream with an extruded cracking catalyst in a reactor unit, where the hydrocarbon feed stream comprises a hydrocarbon comprising at least 5 carbons per molecule, and where the extruded cracking catalyst comprises:
a zeolite composite catalyst mixed with an alumina binder, where the zeolite composite catalyst comprises ZSM-5 comprising a SiO₂/Al₂O₃ molar ratio greater than or equal to 50, and where the alumina binder is peptized with at least 1 wt/wt % phosphoric acid.

10. The method of claim 9, wherein the contacting of the hydrocarbon feed stream with the extruded cracking catalyst occurs at a weight hourly space velocity (WHSV) from 1 h⁻¹ to 50 h⁻¹.

11. The method of claim 9, wherein the contacting of the hydrocarbon feed stream with the extruded cracking catalyst occurs at a temperature from 200° C. to 700° C. and at a pressure from greater than 0 atm to 10 atm.

12. The method of claim 9, wherein the contacting of the hydrocarbon feed stream with the extruded catalyst produces a product stream comprising a total olefin selectivity from 40% to 60%.

13. The method of claim 9, wherein the contacting of the hydrocarbon feed stream with the extruded cracking catalyst produces a product stream comprising a feed conversion from 60 wt % to 100 wt %.

14. The method of claim 9, wherein the contacting of the hydrocarbon feed stream with the extruded cracking catalyst produces a product stream comprising a gas yield from 60 wt % to 99 wt % and a liquid yield from 1 wt % to 40 wt %.

15. The method of claim 9, wherein the hydrocarbon stream comprises gas condensate.
